(19) United States
(12) Patent Application Publication
(10) Pub. No.: US 2002/0054412 A1
(43) Pub. Date: May 9, 2002

(54) Optical wireless communication system with multiple receivers

(76) Inventors: Robert C. Keller, Plano, TX (US); Jose L. Melendez, Plano, TX (US)

Correspondence Address: TEXAS INSTRUMENTS INCORPORATED, P O BOX 655474, M/S 3999, DALLAS, TX, 75265

(21) Appl. No.: 09/839,690

(22) Filed: Apr. 20, 2001

Related U.S. Application Data
(60) Provisional application No. 60/234,074, filed on Sep. 20, 2000.
(60) Provisional application No. 60/234,086, filed on Sep. 20, 2000.
(60) Provisional application No. 60/234,081, filed on Sep. 20, 2000.
(60) Provisional application No. 60/233,851, filed on Sep. 20, 2000.
(60) Provisional application No. 60/271,936, filed on Feb. 26, 2001.

(51) Int. Cl. H04B 10/00; H04B 10/06

(52) U.S. Cl. 359/172; 359/189

(57) ABSTRACT

A cellular optical wireless network 10 includes multiple bi-directional point-to-point links between a central hub 12 and dispersed clients 14. When the hub 14 is limited in size, the receivers may be in close proximity to one another. In this case, the optical signal from two or more clients, which may have spread significantly in diameter due to angular spread in the transmitted light, may overlap spatially at the hub, causing interference and difficulty in separating the data. The present invention provides techniques to avoid such interference.

### CROSS REFERENCE TO RELATED APPLICATIONS

The following co-pending, co-assigned patent applications are related to the present invention. Each of the applications is incorporated herein by reference.

| Ser. No. | Filing Date | Attorney Docket |
|---|---|---|
| 09/621,385 | 7/21/2000 | TI-30713 |
| 09/620,943 | 7/21/2000 | TI-30714 |
| 60/234,074 | 9/20/2000 | TI-31437 |
| 60/234,086 | 9/20/2000 | TI-31436 |
| 60/234,081 | 9/20/2000 | TI-31444 |
| 60/233,851 | 9/20/2000 | TI-31612 |
| 60/271,936 | 2/26/2001 | TI-32675 |
| TBD | concurrently | TI-31440 |
| TBD | concurrently | TI-31441 |

### FIELD OF THE INVENTION

This invention relates generally to communication systems and specifically to an optical wireless communication system with multiple receivers.

### BACKGROUND OF THE INVENTION

Low cost, high bandwidth, wireless data communication is an urgent goal in a number of areas of application. Local area networks (LANs) require high bandwidth data communication, as do infrastructure data communications systems, such as telephony and video systems, including Internet applications. However, the time and expense of installing physical cabling or fiber between network or device nodes in many cases prohibits the practical installation or upgrading of systems. Other applications areas could emerge, once a low-cost high bandwidth data link is available.

RF wireless communication links have been utilized in the prior art. However, such links share bandwidth across multiple users in an area, provide access to the RF signal by all users and non-authorized persons resulting in security concerns, are subject to FCC regulations, and are practically limited to effective bandwidths per user which are much less than that of typical cabling and fiber optics. Open air, optical links have been utilized for data communications in the prior art. However, such links have typically suffered from high cost. One example of such a link uses a galvanometer type actuator for rotational control of an optical system. The optical system in such systems is typically a high precision lens structure mounted on a large, precision mechanical assembly. The resulting system is high performance and high quality, but bulky, expensive, difficult to install and has only a low speed or bandwidth for position adjustment, making it impractical for widespread use.

### SUMMARY OF THE INVENTION

A cellular optical wireless network structure includes multiple bi-directional point-to-point links between a central hub and dispersed clients. Assuming that the hub is limited in size, the receivers may be in close proximity to one another. In this case, the optical signal from two or more clients, which may have spread significantly in diameter due to angular spread in the transmitted light, may overlap spatially at the hub, causing interference and difficulty in separating the data.

A number of methods are proposed for separating the signals. (1) The receiver field of view can be restricted and the receivers arranged so that the closest receivers have different fields of view. (2) Narrow bandpass optical filters can be used and the receivers arranged so that the closest receivers have different optical bandpasses. (3) Orthogonal polarizers can be used on every other receiver. (4) The receivers and/or transmitters can be time division multiplexed. (5) Sub-carriers of the optical carrier can be frequency modulated. Also, combinations of these methods can be employed.

The advantages of implementing one or more of these method include a smaller spacing between receivers in the hub resulting in a high receiver density and therefore smaller and potentially cheaper system, and lower possibility of crosstalk between adjacent receivers. Smaller systems may allow hub deployment locations with higher number of links than larger systems would allow. For example, an optical wireless hub mounted on top of a pole such as a light pole may be limited in size or weight, and therefore a higher receiver count per pole would reduce the number of system deployments and thereby reduce deployment costs.

### BRIEF DESCRIPTION OF THE DRAWINGS

The above features of the present invention will be more clearly understood from consideration of the following descriptions in connection with accompanying drawings in which:

FIG. 1 is an overview of an optical wireless network;

FIG. 2 is block diagram of an optical wireless modem according a preferred embodiment of the present invention;

FIGS. 3a and 3b are the transmitter and receiver of an optical module;

FIG. 4 shows an arrangement of receiver directions allowing separation of incoming light from the same direction;

FIG. 5 shows an arrangement of receiver wavelength sensitivities such that the separation distance between detectors with the same wavelength sensitivity is increases;

FIG. 6 shows an arrangement of receiver polarization such that the adjacent detectors are sensitive to independent polarization;

### DETAILED DESCRIPTION OF ILLUSTRATIVE EMBODIMENTS

The making and use of the various embodiments are discussed below in detail. However, it should be appreciated that the present invention provides many applicable inventive concepts which can be embodied in a wide variety of specific contexts. The specific embodiments discussed are merely illustrative of specific ways to make and use the invention, and do not limit the scope of the invention.

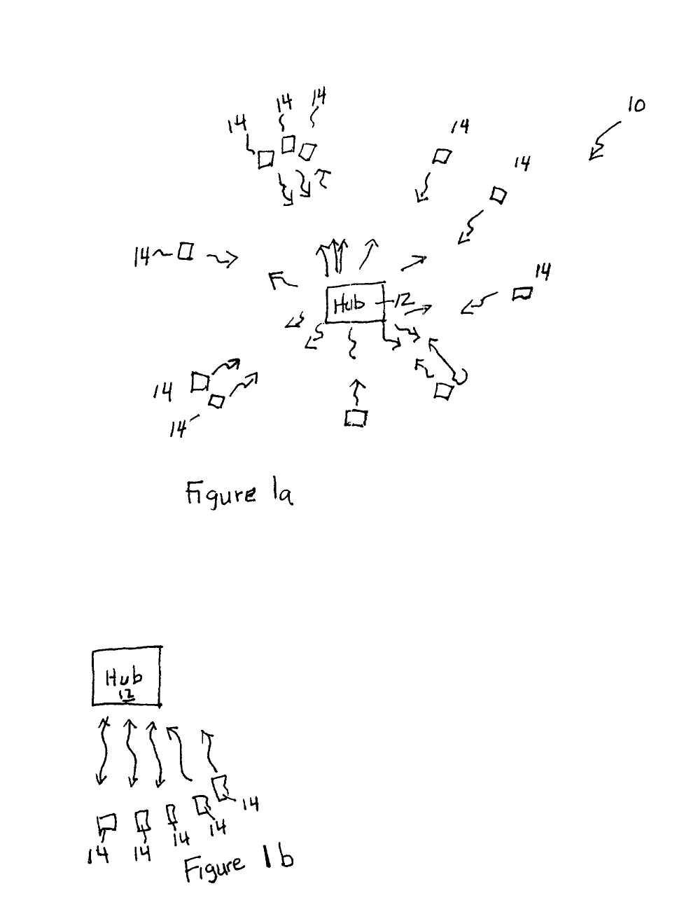

The embodiments of the present invention will now be described with reference to the drawings. FIG. 1 shows an overview of a potential network application of the present invention. Description of a number of implementations then follows.

Referring now to FIG. 1, a local network 10 includes a hub 12 and a number of client units 14. One example could be a cubicle area where the hub 12 is located at a central location within the area and each of the clients 14 is located adjacent one of the cubicles. While not shown, each client 14 could be coupled to a computer (or other device such as a server, printer, fax machine, as examples). This connection can be made through cabling or otherwise. Similarly the hub 12 could be coupled to a larger network and/or to a local server.

While the illustrated example includes a hub 12 which is physically located in the center of a number of units 14, it is understood that this configuration is not required. For example, the hub could be located at one end (e.g., against a wall or in a corner) of the cubicle area. The specific configuration will typically be determined by considerations other than the optical network. Of course, the network is not limited to a cubicle environment. Any environment where multiple computers or other devices are to be connected would benefit from this invention, an example being houses connected to a hub mounted on a tower or pole.

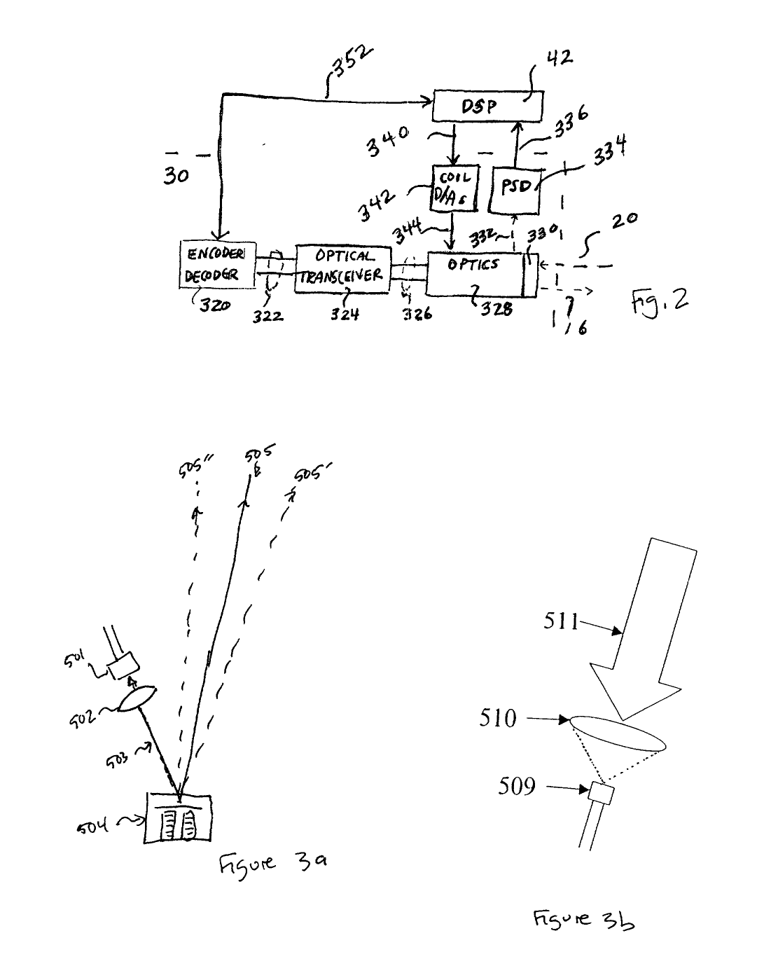

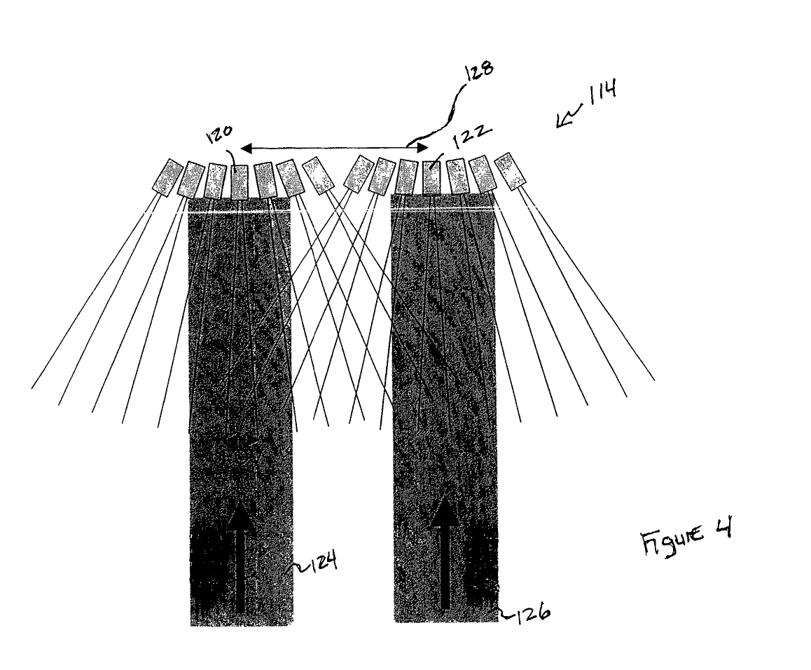

FIGS. 2, 3a and 3b will now be used to describe a preferred embodiment communication device such as would be found in either or both of the hub 12 and unit 14. Further details on these units can be found in the co-pending applications listed at the beginning of the application, each of which is incorporated herein by reference.

One embodiment of an optical module 30 is provided in FIG. 11. The module includes an Encoder/Decoder Unit 320, coupled by a two-way Data Link 322 to an Optical Transceiver Unit (OUT) 324. The OTU 324 acts as an electrical to light and light to electrical converter. It contains a light source, such as a laser or light emitting diode, control electronics for the light source, a photo-detector for converting the received light to electrical signals and amplifiers to boost the electrical strength to that compatible with the decoder.

The OTU 324 can also be of conventional design. For example, a TTC-2C13 available from TrueLight Corporation of Taiwan, R.O.C., provides an advantageous and low cost optical transceiver unit, requiring only a single +5V power supply, consuming low power, and providing high bandwidth. However, it should be noted that OTU units of conventional design can provide less than optimal performance, since such units are typically designed for transmitting and receiving light from fibers. This results in three problems that should be noted by the designer. First, light is contained in such units and is thus not subject to the same eye safety considerations as open air optical systems such as the present invention. Consequently, such units may have excessively high power. Second, light is transmitted to a fiber and thus has optical requirements that are different from those where collimation is required, as in embodiments of the present invention. Third, light is received by such units from a narrow fiber, and therefore such units usually have smaller detector areas than desired for embodiments of the present invention. Accordingly, it is considered preferable to assemble a transceiver having a photodiode and optical design such that the maximum amount of light is collected from a given field of view. This requires as large a photodiode as possible, with the upper limit being influenced by factors such as photodiode speed and cost. In any event source, a preferred light source is a vertical cavity surface emitting laser, sometimes referred to as a VCSEL laser diode. Such laser diodes have, advantageously, a substantially circular cross-section emission beam, a narrow emission cone and less dependence on temperature.

The Optical Transceiver Unit 324 is coupled by a two-way data link 326 to Optics 328. The Optics 328 contains optical components for collimating or focusing the outgoing light beam 16 from the transceiver, a micro-mirror controlled by, e.g., electromagnetic coils, for directing the collimated light in the direction of a second OWL (not shown), with which OWL is in communication, and receiving optics to concentrate the light received from the second OWL on a transceiver photodetector included in the Optics 328. The receiving optics can include a control mirror, either flat or curved, to direct the light to the photodetector. Auxiliary photo detectors can be provided adjacent to the main photodetector for light detection in connection with a control subsystem (not shown), for controlling the control mirror, and maximize the light capture at the photodetector. The Optics 328 may also contain a spectral filter 330 to filter ambient light from the incoming signal light 20. The Optics 328 is preferably, but need not be a micro-mirror. Any controllable beam steering device can be used that changes the direction of the light beam without changing the orientation of the light emitter. In addition, a basic function of the Optics 328 is that it sufficiently collimates the light beam that will (1) substantially fit within the micro-mirror reflecting area, and (2) preserve the minimum detectable power density over the distance of the link. Laser diodes generally meet these criteria, and as such are preferred. However, light emitting diodes (LEDs) and other light sources can be made to satisfy these criteria as well.

For optical wireless links across large distances where the highest possible optical power density at the receiver is needed for robust transmission, the optical portion of the preferred embodiments should preferably be selected to achieve a divergence of less than 0.5 mrad, which is to be contrasted with the prior art system that have divergences in the range of 2.5 mrad. The divergence of less than 0.5 mrad results in an optical density greater than 25 times the optical density of the prior art systems, which, for the same received optical power density corresponds to 5 or more times longer range.

The optical receiver portion of this embodiment should be selected to have an intermediate size, preferably having a diameter in the range of 0.5 millimeter (mm) to 1 centimeter (cm). If the diameter is much smaller than 0.5 mm, it may be difficult to collect enough of the light directed on the receiver. On the other hand, if the diameter is much larger than 1 cm, the responsiveness of the detector may diminish to the point where the performance of the system is compromised.

The Optics 328 are coupled by an optical path 332 to a Position Sensitive Detector (“PSD”) 334. The PSD 334 measures the angular deflection of the micro-mirror in two planes. This can be accomplished by detecting the position of a spot of light on a sensor in the PSD 334. The analog signals representing these angular deflections are converted into signals and sent on lines 336 to a Digital Signal Processor (“DSP”) 42 for closed loop control of the micro-mirror in Optics 328. PSDs are well known in the art, and PSD 334 may be any of a variety of types, including a single diode Si PSD, CMOS photo-detector array, and the like. All that is required of PSD 334 is that it sense, in two directions, the position of a spot of light impinging thereon, and provide as outputs digital signals representative of such position.

However, note that the use of analog control signals is not required in the practice of the present invention. Other known control signal approaches can be used. For example, pulse-width modulation may be used to provide such control. Such choices of control system are well within the purview of those of ordinary skill in this art. A preferable approach to micro-mirror position detection is to employ sensors on the actual micro-mirror itself, as described in greater detail in co-pending and commonly assigned patent applications No. 60/233,851 (“Packaged Mirror with In Package Feedback”) and No. 60/234,081 (“Optical Wireless Networking with Direct Beam Pointing”), which applications are incorporated herein by reference.

In addition to receiving the signal lines 336 from the PSD 334, the DSP 42 sends coil control signals on lines 340 to a set of coil digital to analog converters (“D/As”) 342. The D/As 342 are, in turn, connected by way of lines 344 to a corresponding set of coils in optics 328. Finally, the DSP 42 is connected via line 352 to send and receive OAM data to/from encoder/decoder 320. The DSP 42 operates as a link control. It controls the micro-mirror deflections by controlling the coil currents through the D/As 342. Information on the instantaneous micro-mirror deflections is received from the PSD 334 for optional closed loop control.

The DSP 42 also exchanges information to the second OWL to orient the beam steering micro-mirror in the proper direction for the link to be established and maintained. The DSP may also exchange OAM information with the second OWL across the optical link maintained by Optical Module 328. DSP 42 may be any suitable DSP, of which many are commercially available. Preferably, the DSP is the DSP provided for by control logic 26, as discussed above, although a second distinct DSP could optionally be used.

In addition, note that a single processor may control multiple OWL links. This capability can be very valuable for use in a network hub, where multiple links originate or terminate in a single physical network switch. A single DSP could provide a very cost efficient control facility in such cases. In all such cases, the requirements for this processor are a sufficiently high instruction processing rate in order to control the specified number of micro-mirrors, and a sufficient number of input/output (“I/O”) ports to manage control subsystem devices and peripheral functions.

In an alternative embodiment, the alignment information can be fed back to the transmitting unit in other ways than as a separate control packet. For instance, in one embodiment, the alignment information can be imposed upon the optical beam itself using low frequency, small signal modulation. In another alternative embodiment, the control packets and the data packets can be interleaved into a new higher rate data stream. Yet another approach is to “disguise” the control packet as a normal data packet of the data stream. One example would be in a system wherein the OWL devices are transmitting using a Voice over Packet (VOP) protocol, although the concept would apply. In other embodiments, a separate channel (not shown) can be used to communicate the alignment information. For example, a wireless RF link or a wired link could be used.

The optical module 228 will now be described. This unit is very compact, high speed in operation, low cost and reliable in operation. The optical module contains a transmitter section, shown in FIG. 3a, and a receiver section, shown in FIG. 3b.

In the transmitter section, light emitted by the light source 501 in the optical transceiver unit is focused or collimated by lens 502 in an optical beam 503. The optical beam 503 is reflected by a mirror in a rotatable mirror assembly 504, the mirror being shown in its middle or neutral unpowered position, in direction 505. The rotatable mirror is moveable between two opposite extremes, with optical beam 503 correspondingly reflected to 505′, 505″ at the extremes. The rotatable mirror is described in greater detail in co-pending application Ser. No. 09/620,943 (TI-30714). Although the movement of the mirror shown in FIG. 3a illustrates movement in one plane, mirror movement in a second plane is also included in the operation of the optical wireless link.

The receiver section of the optical module contains optics 510 for concentrating in incoming light 511 onto the photodiode 509 in the optical transceiver unit to increase the received optical signal. The optics can be imaging optics with the photodiode at the focal plane or non-imaging optics such as a Winston cone.

In one embodiment, a cellular optical wireless network structure would include multiple bi-directional point-to-point links between a central hub 12 and dispersed clients 14. An advantage of the cellular structure is that hub 12 can be connected to a higher speed backbone network (fiber optic for example), without the cost of deploying the backbone network to each client 14. Assuming that the hub 12 is limited in size, as would be the case for a tower hub, the receivers with the hub may be in close proximity to one another. In this case, the optical signal from two or more clients, which may have spread significantly in diameter due to angular spread in the transmitted light, may overlap spatially at the hub 12, causing interference and difficulty to separate the data. In one aspect, the present invention strives to increase the spacing between receivers that can detect the same optical signal such that the incoming optical signal do not overlap spatially while maintaining a maximum total number of receiver at the hub.

The optical signal strength at the receiver is defined by the amount of transmitted light that adsorbed by the receiving photodiode 509. The effective collection area of the receiver is sometimes increased by use of concentrating optics (e.g., imaging lenses or non-imaging optics) that also inherently limit the receivers field of view. The field of view can also be limited by including blocking optics such as a tube.

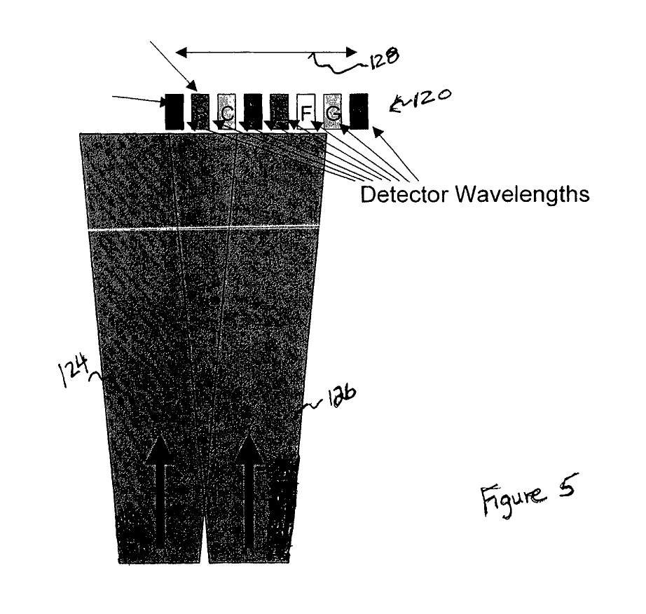

To increase the separation distance between receivers that could detect incoming light from clients in nearly the same direction from the hub 14, the field of views receivers in closest spatial proximity can be pointed in different directions such that their fields of views do not over lap. This increases the spatial separation between receivers with overlapping field of views. This is illustrated in FIG. 4. Although the figure shows a one-dimensional array of receivers, the technique will also work for a two-dimensional array of receivers.

FIG. 4 illustrates a receiver hub 114 that includes fourteen separate receivers. In this example, two receivers 120 and 122 are designed to receive optical signals from the same angular direction. That is, these receivers have the same field of view. As shown, receiver 120 receives incoming light 124 from a first client while receiver 122 receives incoming light 126 from a second client. The distance 128 between these receivers 120 and 122 with the same field of view is great enough to prevent the incoming light 124 from interfering with incoming light 126. The minimum value for distance 128 will be determined by a number of factors including the diameter of the receiver and the width of light beam 124/126 (typically a function of the distance from the second client).

A typical receiver of the preferred embodiment will be able to capture light impinging within about ±5 degrees from normal (thereby defining the field of view). As result, any adjacent receiver with a field of view less than about ±5 degrees will not receive any light intended for the receiver 120/122. This feature is illustrated by the field of view lines extending from each of the receivers in FIG. 4.

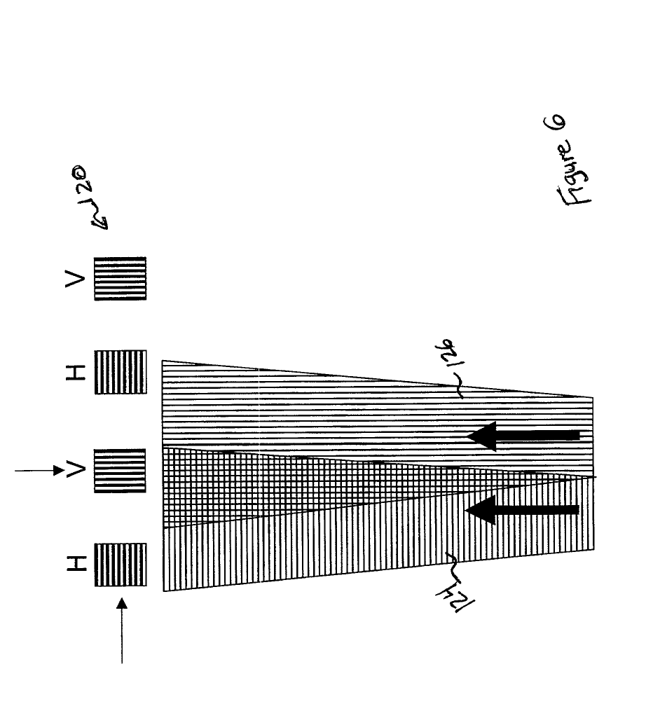

Another technique for ensuring that the incoming light for adjacent receivers does not interfere is separation by optical wavelength as illustrated in FIG. 5. Lasers commonly used in high bandwidth optical data transmission have very narrow linewidths (i.e., the wavelength of the emitted light is confine in a very narrow range). By using narrow band optical filters at the receivers 120, each receiver 120 can be made sensitive only to a specific wavelength range. To increase the separation distance 128 between receivers that could detect incoming light from clients in nearly the same direction from the hub, the spectral sensitivity of receivers in closest spatial proximity can varied such that the receiver cannot detect the same wavelengths of other nearby receivers. By choosing client transmitter wavelengths such that clients each a different wavelength, the incoming light at the hub can overlap and still be detected by only a single detector.

In FIG. 5, eight receivers 120 are shown for the purpose of illustration. The letter A-G indicates that different ones of these receivers are sensitive to different wavelength light. To avoid interference, the two receivers labeled A should be separated by a minimum distance 128. The same holds true for any other two receivers that utilize the same wavelength (even though none are shown).

FIG. 6 illustrates the case wherein different optical channels are separated by polarization. Light (and all electromagnetic radiation) can be polarized such that the electric field lies in one direction. When the light passes through a polarizer with its polarization parallel to the light polarization, the light is passed. When the light passes through a polarizer with its polarization perpendicular to the light polarization, the light is blocked. By using receivers 120 with polarizers such that the polarization the receiver polarizer is orthogonal to that of its neighbor, two neighboring receivers would detect light transmitted from two clients with similarly orthogonal polarization independently. The two orthogonal transmitter polarization should be consistent between the transmitter and receiver, such as horizontal and vertical. This techniques works because air will preserve the polarization of light. This scheme is used to increase the number of sectors per hub in microwave LMDS transmitters.

Other techniques could also be utilized. For example, the optical channels can be separated by time division multiplexing. By coordinating the transmission of data by multiple clients in a known manner such that only one client is transmitting at one time, multiple clients can transmit data to a single receiver. In this case, the transmitted light will overlap spatially but not at the same time. The disadvantage of this scheme is that the bandwidth of the receiver is divided among multiple clients, decreasing the bandwidth for each client associated with that receiver. This scheme is broadly used with RF wireless systems such as cell phones as well as LED based indoor LANs.

Sub-carrier frequency modulation can be used to separate the optical channels. The intensity of light from laser diodes can be modulated at a frequency of 10 GHz or higher. Data can be transmitted using sub-carrier modulation of the light with modulation formats including Frequency Shift Keying (FSK), Phase Shift Keying (PSK) and Amplitude Shift Keying (ASK).

The photodetector in the receiver converts the light amplitude to an electrical signal. By using an electrical circuit which is sensitive to only the sub-carrier frequency band of one client transmitter, the data from that client can be separated from the signal from clients with different, independent sub-carrier frequency bands. Therefore, either one optical receiver can be used to detect multiple client signals with different sub-carrier modulation, or each receiver can be tuned to the sub-carrier frequency of one client. This allows the signals from multiple spatially overlapping client transmissions to be separated at the hub.

Multiple of the above methods can be combined to further increase the number of overlapping client transmissions that can independently detected. For example, if one used receiver angle, polarization and wavelength separation methods together with 10 independent fields of view, 2 polarization directions and 10 wavelengths, 200 overlapping client transmissions could be independently distinguished.

The present invention has, for the most part, been described in the context of a network. It is noted that the inventive concepts would also apply to other applications. For example, a single computer could have two optical wireless connections to one or two (or more) other devices. If these communication paths are closely aligned then the techniques of the present invention can be used.

While this invention has been described with reference to illustrative embodiments, this description is not intended to be construed in a limiting sense. Various modifications and combinations of the illustrative embodiments, as well as other embodiments of the invention, will be apparent to persons skilled in the art upon reference to the description. It is therefore intended that the appended claims encompass any such modifications or embodiments.

What is claimed is:

1. An optical wireless hub device comprising:
an optical module including a plurality of optical receivers, each optical receiver configured to receive a unique optical wireless signal, the optical module being configured to distinguish each unique optical wireless signal at one of the optical receivers;
processor circuitry coupled to the plurality of optical receivers, the processor circuitry receiving electrical signals derived from the optical wireless signals; and
an interface unit coupled to the processor circuitry.

2. The device of claim 1 wherein different ones of the optical receivers are aligned to have different fields of view such that each incoming optical beam can be viewed by at most one receiver.

3. The device of claim 1 wherein different ones of the optical receivers are aligned with adjacent receivers have different fields of view such that each incoming optical beam cannot be viewed at the same time by two adjacent receivers.

4. The device of claim 1 wherein different ones of the optical receivers are aligned so that no receivers within a certain area have coincident fields of view such that each incoming optical beam cannot be viewed by any two receivers in said area at the same time.

5. The device of claim 1 wherein each optical receiver includes a filter so that the receiver receives optical signals within a limited range of wavelengths.

6. The device of claim 5 wherein each optical receiver located so that it can receive no more than one of the unique optical wireless signals.

7. The device of claim 1 wherein some of the optical receivers include a filter that only passes a first polarization of light and others of the optical receivers include a filter that only passes a second polarization of light, the first polarization being substantially orthogonal to the second polarization.

8. The device of claim 1 wherein different ones of the optical receivers are enabled and disabled over time such that each optical receiver can receive no more than one of the unique optical wireless signals.

9. The device of claim 1 wherein one of the optical receivers is configured to receive at least first and second unique optical wireless signals, the first and second unique optical wireless signals being time division multiplexed.

10. The device of claim 1 wherein each of the unique optical wireless signals includes a modulated sub-carrier signal and wherein each of the optical receivers is configured to receive source information from the modulated sub-carrier signal.

11. The device of claim 1 wherein the optical module is configured to distinguish each unique optical wireless signal at only a respective one of the optical receivers using at least two techniques, the at least two techniques selected from field of view, wavelength filter, polarization filter, time division multiplexing and subcarrier modulation.

12. The device of claim 1 wherein the processor circuitry comprises a digital signal processor.

13. The device of claim 1 wherein the process circuitry comprises a microcontroller.

14. The device of claim 1 wherein the interface unit comprises a physical layer device.

15. An optical wireless communication device comprising:
a first optical wireless receiver having a photodetector with a first field of view;
a second optical wireless receiver having a photodetector with a second field of view, the second field of view being at least five degrees out of line with the first field of view; and
processing circuitry coupled to the first and to the second optical wireless receivers, the processing circuitry receiving first data from a first remote source and second data from a second remote source, the first data being received through the first optical wireless receiver and the second data being received through the second optical receiver.

16. The device of claim 15 wherein the first optical wireless receiver further includes a polarization filter.

17. The device of claim 15 wherein the first optical wireless receiver further includes a wavelength filter.

18. The device of claim 15 wherein the optical wireless communication device further comprises a transmitter, the transmitter comprising:
a source of light having a beam of light;
a controllable beam steering device; and
an actuator to permit steering said light beam, the beam steering device being controllable by predetermined control signals.

19. The device of claim 15 wherein the optical wireless communication device further comprises a plurality of additional optical receivers, at least some of the additional optical receivers having a photodetector with said first field of view.

20. A method of communicating with a optical wireless signal, the method comprising:
receiving a first optical wireless signal from a first source;
receiving a second optical wireless signal from a second source; and
distinguishing between the first optical wireless signal and the second optical wireless signal.

21. The method of claim 20 wherein the distinguishing step is accomplished by receiving the first optical wireless signal at a first angle and receiving the second optical wireless signal at a second angle that is different than the first angle.

22. The method of claim 21 wherein the first angle is at least five degrees different than the second angle.

23. The method of claim 20 wherein the first optical wireless signal centered around a first wavelength and the second optical wireless signal is centered around a second wavelength.

24. The method of claim 20 wherein the first optical wireless signal has a first polarization and the second optical wireless signal has a second polarization, the second polarization being substantially orthogonal to the first polarization.
